(19) United States
(12) Patent Application Publication
(10) Pub. No.: US 2007/0092324 A1
(43) Pub. Date: Apr. 26, 2007

(54) Device and method for printing

(76) Inventors: Anthony D. Studer, Albany, OR (US); Kevin D. Almen, Albany, OR (US); Gary G. Lutnesky, Corvallis, OR (US); Kevin E. Swier, Albany, OR (US); Sang O. Bradley, Corvallis, OR (US); Raymon Dale Burrows, Albany, OR (US); Tony S. Cruz-Uribe, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/256,031

(22) Filed: Oct. 21, 2005

(51) Int. Cl. B41J 3/36; B41J 2/01; B41J 29/38

(52) U.S. Cl. 400/76; 400/88

(57) ABSTRACT

A hand-held printing device having a hand-operated actuator that moves a print head relative to a print medium and at least one sensor. The hand-held printing device further has logic configured to perform at least one power-using operation of the hand-held device based on an output from the at least one sensor.

### BACKGROUND

A typical hand-held, self-contained printing device comprises a housing and an actuator. A user manually positions the housing on a medium, e.g., an envelope, a box, a piece of paper, and actuates the actuator. When the actuator actuates, the printing device prints an image onto the medium.

Some hand-held printers may be mechanical. In this regard, the actuator mechanically moves a stamp, for example, in the direction of the medium. When the stamp moves and contacts the medium, the image is printed to the medium. However, manually actuated mechanical hand-held printers are limited in their use, scope, and functionality.

### SUMMARY OF THE DISCLOSURE

Generally, the present disclosure provides a hand-held device and method for printing images to a medium, for example addresses, signatures, emoticons, postage, and the like.

A hand-held device in accordance with an embodiment of the present disclosure has a hand-operated actuator that moves a print head relative to a print medium and at least one sensor. The hand-held printing device further has logic that performs at least one power-using operation of the hand-held device based on an output from the at least one sensor.

A method in accordance with an exemplary embodiment of the present disclosure comprises detecting, via a sensor, whether a hand-held printing device is properly positioned on a medium and performing at least one power using operation of the hand-held device based on an output from at least one sensor.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a hand-held printing system in accordance with an exemplary embodiment of the present disclosure.

FIG. 2 is a block diagram illustrating the hand-held printing device of FIG. 1 actuated in accordance with an exemplary embodiment of the present disclosure.

FIG. 3 is a block diagram of an exemplary hand-held printing device as depicted in FIG. 1.

FIG. 4 is a flow chart illustrating an exemplary architecture and functionality of control logic as depicted in FIG. 1 for printing on a forward stroke or bi-directionally.

FIG. 5 is a flow chart illustrating an exemplary architecture and functionality of control logic as depicted in FIG. 1 for printing on a forward stroke or bi-directionally.

FIG. 6 is a flow chart illustrating an exemplary architecture and functionality of control logic as depicted in FIG. 1 for printing on a reverse stroke.

FIG. 7 is a flow chart illustrating an exemplary architecture and functionality of control logic as depicted in FIG. 1 for printing on a reverse stroke.

FIG. 8 is a flow chart illustrating an exemplary architecture and functionality of control logic as depicted in FIG. 1 for cancelling a print on a reverse stroke.

FIG. 9 is a flow chart illustrating an exemplary architecture and functionality of control logic as depicted in FIG. 1 for cancelling a print on a reverse stroke.

### DETAILED DESCRIPTION

Embodiments of the present disclosure generally pertain to hand-held printing devices and methods.

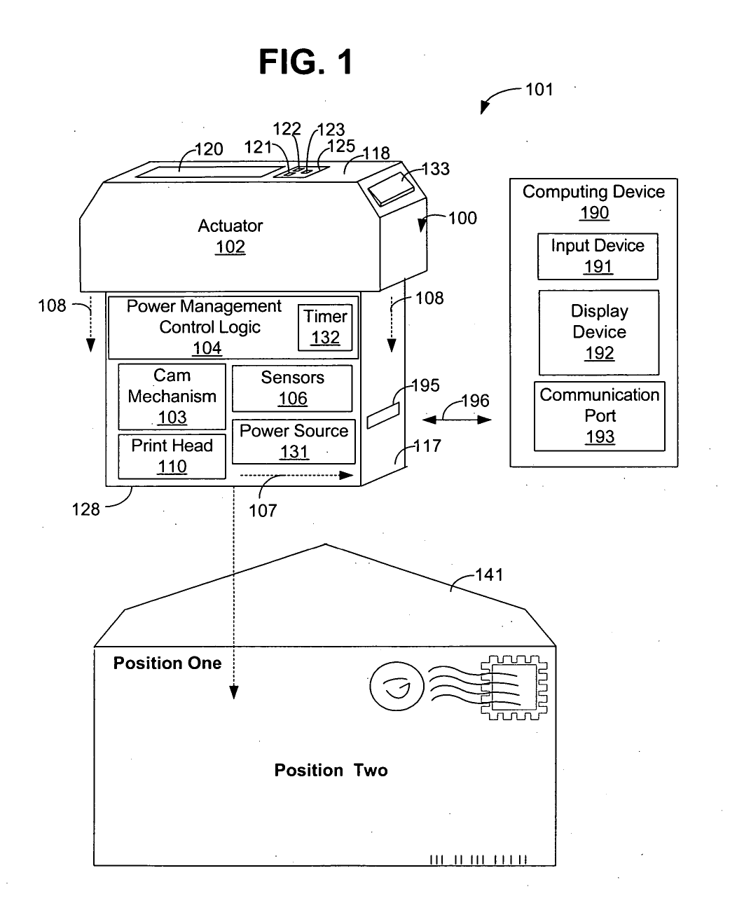

FIG. 1 depicts a system 101 comprising a hand-held printing device 100 in accordance with an exemplary embodiment of the present disclosure and a computing device 190. The hand-held printing device 100 comprises a case 117 and an actuator 102. The case 117 has an aperture (not shown) at an end 128 opposing the actuator 102 and comprises a print head 110.

During normal operation, a user (not shown) manually positions the end 128 of the hand-held printing device 100 adjacent a print medium, e.g., an envelope 141, a box, or a piece of paper, at a position on the medium, e.g., “position one” or “position two” on envelope 141, where the user desires to print an image.

In this regard, the printing device 100 further comprises an input device 125 and a display device 120. Note that the input device 125 shown in FIG. 1 is a keypad comprising a plurality of buttons 121-123, however, other input devices in other embodiments are possible. Further note that the display device 120 for displaying information to the user is any type of display device known or future-developed, e.g., a liquid crystal display (LCD). The user (not shown) uses the input device 125 in conjunction with the display device 120 to select particular images for printing.

Furthermore, while an input device 125 and a display device 120 are depicted as being integral with the device 100 in FIG. 1, other devices for inputting and viewing images may be used in other embodiments. For example, FIG. 1 depicts the computing device 190, e.g., a desktop computer. The computing device 190 comprises an input device 191, a display device 192, and a communication port 193. For exemplary purposes, the input device 191 may be a mouse or a keyboard, and the display device 192 may be a display screen. Furthermore, the communication port 193 may comprise any type of communication port known in the art, such as, for example, a universal serial bus (USB) port, an infrared wireless port, a radio frequency (RF) port, or other wireless connection. In this regard, the computing device 190 can transmit data to the device 100 via a connection 196 to a port 195 on the device 100.

During operation, the user may use the input device 191 to select images displayed on the display device 192 for printing by the device 100. The computing device 190 then transmits data indicative of the selected images to the device 100 via the connection 196. The user may then print the transmitted images to the envelope 141.

Note that FIG. 1 depicts the envelope 141 as a medium on which the user might desire to print selected images. In this regard, the user might desire to print a return address at “position one” or a recipient address at “position two” on the envelope 141, for example. Note that envelope 141 is depicted as a desired medium for exemplary purposes only, and the hand-held printing device 100 can be used to print images on other types of media including, but not limited to boxes, letters, and the like.

Further note that the actuator 102 can be any type of device known or future-developed, including a mechanical actuator, electronic actuator or combination thereof, that transmits an image to the print head 110 and moves the print head 110. Further note that the print head 110 can be any known or future-developed device for transferring an image to the desired medium. For example, the print head 110 may be a thermal ink jet (TIJ), a piezoelectric, or thermal print engine, and printing is enabled by transferring image data to the print head 110. Note that the print head 110 is powered by a power source 131, e.g., a battery.

A TIJ print head comprises a plurality of jets (not shown), each in turn comprising a chamber (not shown) with a nozzle (not shown), and an inlet (not shown). Each chamber comprises a resistor (not shown) that generates heat when a current is applied to the resistor. The heat generated by each resistor is sufficient to vaporize ink (not shown) that is contained within the chamber, thus creating a bubble in the chamber. As the bubble expands, ink is forced out of the nozzle onto the medium. Inevitably, the bubble collapses creating a vacuum, which pulls ink through the inlet from an ink source (not shown) back into the chamber.

A piezoelectric print head comprises a plurality of jets (not shown), as well. However, each chamber in the piezoelectric print head comprises a flexible wall to which a piezoceramic is affixed externally to the chamber. When the piezoceramic receives an electric charge, it changes length. Such dimensional change bends the flexible wall into the chamber to force ink from the nozzle onto the medium. When the charge is removed, the piezoceramic and flexible wall return to their original shape, which pulls ink through the inlet from an ink source (not shown) back into the chamber.

The user manually positions the end 128 of the hand-held printing device 100 adjacent the desired envelope 141 at a desired position, e.g., “Position One” or “Position Two.” Once the user has manually positioned the end 128 of the hand-held printing device 100 at a desired position adjacent the medium 141, the user applies a manual force to the actuator 102, which causes the print head 110 to print a desired image to the envelope 141 at the position manually selected by the user.

In one embodiment, when the user actuates the actuator 102, the actuator 102 moves in a direction indicated by the arrows 108. Thus, the actuator moves in a vertical direction with respect to the envelope 141. Further, a cam mechanism 103, e.g., a cam that mechanically translates motion in one direction into motion in a differing direction, is mechanically coupled to the print head 110. Thus, when a user (not shown) applies manual force to the actuator 102 thereby moving the actuator 102 in the direction of the reference arrows 108, the cam mechanism 103 moves the print head 110 horizontally in the direction indicated by a reference arrow 107. Such movement by the print head 110 is hereinafter referred to as a “forward stroke.”

In other embodiments, the device 100 may comprise an actuation button, and when the user desires to print an image to the medium, the user depresses the button. The button may transmit a signal to a motor (not shown) that moves the print head 110 relative to the medium.

In another embodiment, the device 100 may comprise a button that, when actuated, transmits an image to the print head 110. However, in order to transfer the image to the medium, the user moves the device 100 in a motion parallel to the medium. As the user moves the device 100 parallel to the medium, the print head 110 transfers the image to the medium. In this regard, the device 100 may comprise, for example, rollers (not shown). The user may actuate the button and manually move the device 100 in the horizontal direction 107. In such an embodiment, the print head 110 would be stationary, i.e., within its housing, and the manual movement of the print head 110 by the user would print the image that is being provided to the print head 110 to the envelope 141.

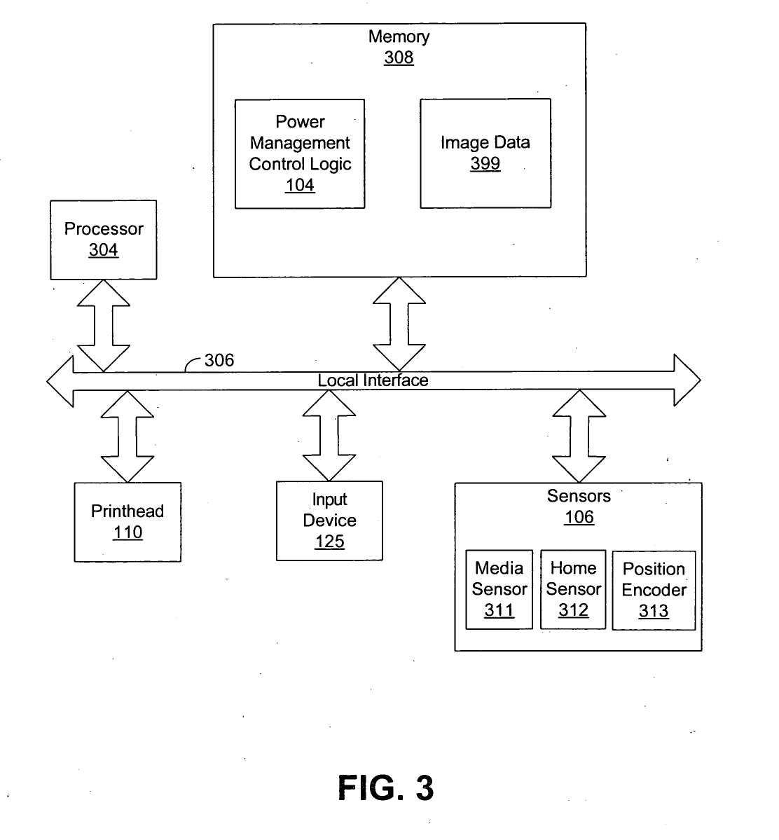

The hand-held device 100 may further comprise sensors 106 for use in controlling printing of images to the envelope 141, and such sensors 106 are described in more detail with reference to FIG. 3. Notably, however, the sensors 106 may be configured to detect the presence of appropriate media on which an image could be transferred, i.e., whether the printing surface is the correct type, the appropriate distance, flat and/or sufficiently rigid for adequate printing thereon. Such a sensor is hereinafter referred to as a “media sensor” and is described further herein with reference to FIG. 3. Other media sensors may further include sensors for detecting whether the device 100 is tilted relative to the medium.

Further, sensors 106 may comprise a sensor for detecting whether the print head 110 is at rest or whether the aperture at the end 128 has been uncapped. Such a sensor is hereinafter referred to as a “home sensor” and is described further herein with reference to FIG. 3. Note that the device 100 may comprise a cap (not shown) that covers the end 128 thereby protecting the aperture.

Additionally, the sensors 106 may comprise a position feedback sensor for detecting the position of the print head 110 in order to determine if the print head 110 is in a position to begin printing or if the print head 110 is moving and in what direction. Such a sensor is hereinafter referred to as a “position encoder” and is described further herein with reference to FIG. 3. Notably, each of the described sensors is powered by the power source 131.

As described hereinabove, once the user applies force to the actuator 102, the actuator 102 activates the print head 110. In this regard, a forward stroke of the print head 110 moves the print head 110 in the direction indicated by the reference arrow 107. Such travel is preferably accomplished via a print head carriage (not shown). However, other devices for moving the print head 110 for printing are possible in other embodiments. Note that when the print head 110 is not moving, it is in a position as shown in FIG. 1, and such a position is hereinafter referred to as the print head's “rest position.”

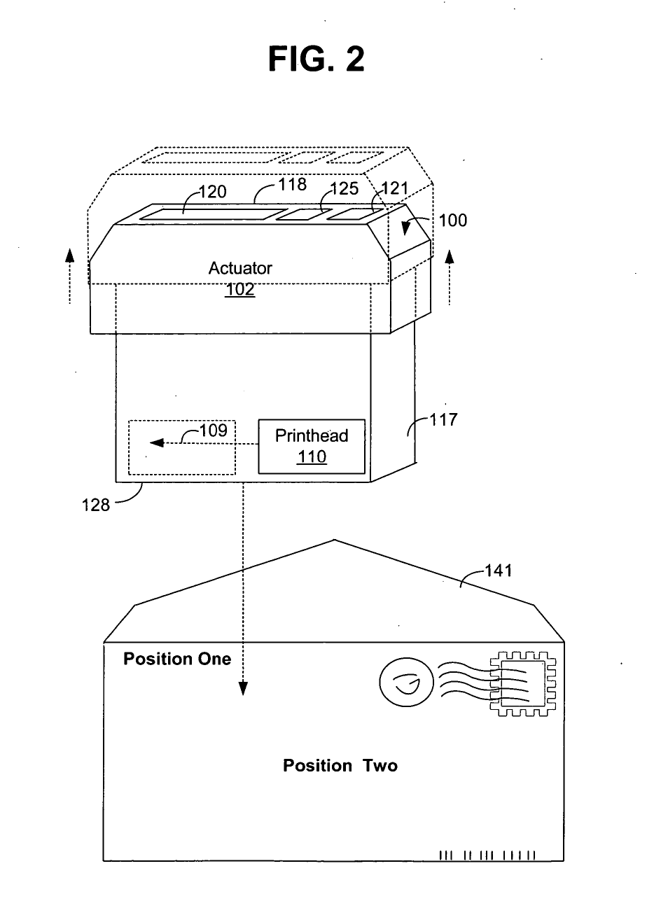

FIG. 2 depicts a position of the print head 110 at its farthest traveling position from the position of the print head 110 shown in FIG. 1. In this regard, the position in FIG. 2 depicts the horizontal travel range of the print head 110, hereinafter referred to as the “fully activated position.” Once the print head 110 reaches the fully activated position, the print head 110 then travels back to the rest position depicted in FIG. 1. As the print head 110 travels from the activated position to the rest position it moves in a direction indicated by the reference arrow 109. Such movement is hereinafter referred to as a “reverse stroke.”

As noted hereinabove, while a vertical motion manual actuator 102 is shown in FIG. 1, other types of manual actuator 102 or electronic actuators (not shown) in other embodiments are possible. For example, the print head 110 may be moved electronically via a button (not shown) located on the hand-held printing device 100 in conjunction with an electronic device to move the print head 110. In this regard, the actuator 102 may comprise a surface 118, and the surface may comprise a button (not shown) for activating the print head 110.

The exemplary printing device 100 further comprises power management control logic 104. The power management control logic 104 controls receiving an image selection from a user (not shown), via the input device 125, and transmitting data indicative of the selected image to the print head 110. During such process, the power management control logic 104 additionally controls activation of various electrically-powered operations within the printing device 100, e.g., those operations related to the sensors 106, the power source 131, and the print head 110, and the power management control logic 104 preferably controls such operations to minimize use of the power source 131, thereby prolonging the life of the power source 131. Such operations are hereinafter referred to as “power-using operations.”

In one embodiment, the user powers on the device 100 via the input device 125. When the device is powered on, the power management control logic 104 activates various sensors 106 and activates a timer 132 based upon feedback from the sensors 106-and the input device 125. For example, the control logic 104 may determine from a portion of the sensors 106 whether the device 100 is positioned on an appropriate medium before activating, e.g., applying power to, the other sensors 106 in the printing device 100. The control logic 104 may also first determine whether the print head 110 is at the print head rest position before activating some of the sensors 106. Furthermore, the control logic 104 may detect whether data indicative of a selected image has been downloaded to the print head 110.

In this regard, the control logic 104 may selectively synchronize the time and/or date stored on the device 100, power on sensors 106, and/or warm the print head 110 depending upon actions and/or inaction taken by the user or depending upon outputs from various sensors 106 of the device 100. Note that warming the print head refers to an operation that readies the print head 110 for printing, i.e., provides current to the resistors in the TIJ print head, or provides current to the crystals in a piezoelectric print head at a lower level than what is required to print. Notably, by waiting until the device 100 is properly positioned or otherwise ready for printing to perform power-using operations, the control logic 104 prolongs the life of the power source 131. Such is described further with reference to FIG. 3.

In another embodiment, the control logic 104 determines whether the print head 110 is in its rest position. If the print head 110 is in the print head rest position, then the control logic 104 waits until the user initiates a print cycle, e.g., by actuating the actuator 102, before it warms the print head 110, for example.

Furthermore, once the sensors 106 are powered on, as described further herein, the control logic 104 continues to monitor the sensors 106, and if the status of any of the sensors 106 changes before the user has completed a print cycle, then the control logic 104 terminates the print cycle. In terminating the print cycle, the control logic terminates power to the sensors 106, the print head 110, and other components using the power source 131. Therefore, the control logic 104 further prolongs the life of the power source 131.

Once the user actuates the actuator 102 and begins a print cycle, the control logic 104 may continue to monitor the various sensors 106. Therefore, if the status of the print cycle changes, then the control logic 104 may terminate the print cycle and return the print head 110 to its rest position for a next print cycle.

Furthermore, during operation, the control logic 104 monitors the timer 132. In this regard, the timer 132 is configured to track the amount of time that the device 100 is idle and power off the device if it is idle after a predetermined amount of time. The timer 132 may be fixed to a particular predetermined time or the timer 132 may be configurable by the user via the input device 125.

Thus, when the device 100 is powered on, as described hereinabove, the control logic 104 may start the timer 132. If the user selects an image or uses the input device 125 to perform other functions, the control logic 104 may reset the timer. Additionally, the timer 132 may be reset when the user begins printing. If the device 100 is idle for the predetermined amount of time, then the control logic 104 may power down the device 100. Therefore, the timer 132 also serves to prolong the life of the power source 131 by minimizing the amount of time that the device 100 is on when it is not in use.

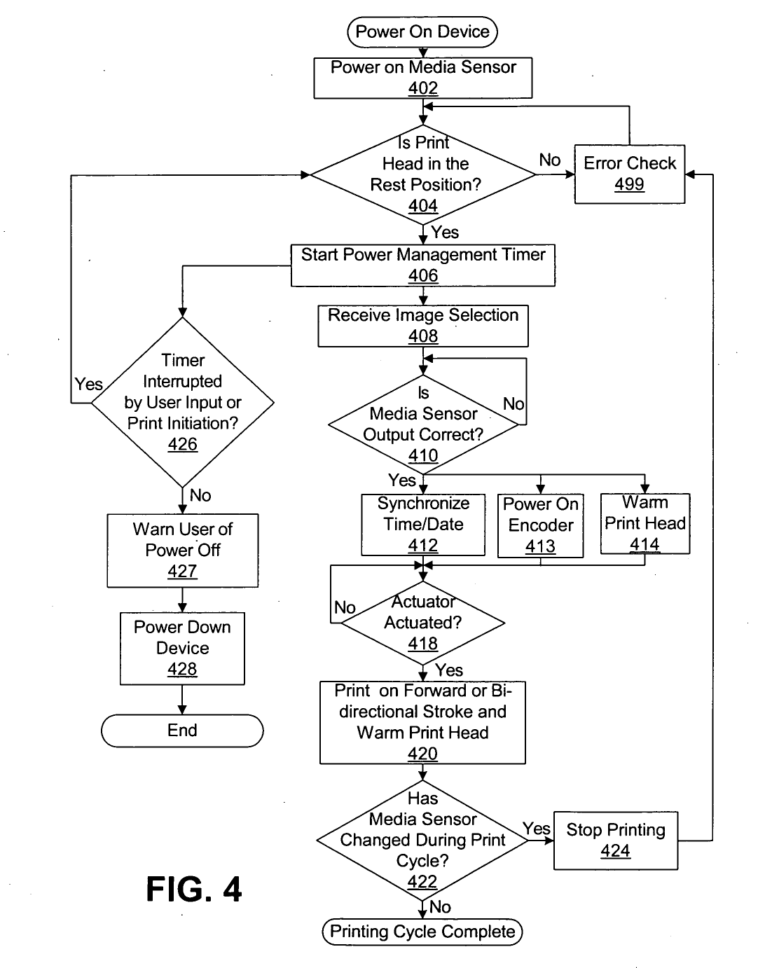

The control logic 104 may transmit the selected image to the print head 110 to be printed on the forward stroke, the reverse stroke, or bi-directionally, each of which is described further with reference to FIGS. 4-9. Note that “bi-directionally refers to printing at least a portion of the image on the forward stroke and a portion on the reverse stroke.

In one embodiment, when the user actuates the actuator 102, the print head 110 prints the selected image on the forward stroke and/or the bi-directional stroke. In other embodiments, the print head 110 prints the selected image on the reverse stroke. In such an embodiment, the device 100 may further comprise a cancellation button 133 (FIG. 1).

In this regard, if the control logic 104 is configured to print on the reverse stroke, the user may desire to terminate the print cycle before the print cycle is complete. In order to terminate the print cycle, the user depresses button 133. The control logic 104 detects that the cancellation button 133 has been depressed, and terminates the print cycle. If the button 133 is depressed during the forward stroke of the print cycle, as described hereinabove, then the image is not transferred to the medium.

Furthermore, the power management logic 104 may vary when power-using operations are performed during a print cycle depending upon whether the print head 110 prints on the forward stroke, the reverse stroke, or bi-directionally. As described herein, one such power-using operation is warming the print head 110. When the print head 110 prints on the forward stroke, the print head 110 is warmed prior to when the forward stroke begins. If, however, the print head 110 prints on the reverse stroke, then the print head 110 can be warmed during the forward stroke for printing on the reverse stroke. Furthermore, if the print head 110 prints on the forward stroke and the backward stroke, then the print head 110 may be warmed on the forward stroke and the backward stroke.

Furthermore, prior to warming the print head 110, the control logic 104 determines whether the device 100 is positioned adjacent media that is appropriate for printing, e.g., the surface is substantially flat. Therefore, the control logic 104 does not warm the print head 110 until it appears that a print cycle is beginning, thereby conserving the device's resources.

It should be noted that the power management control logic 104 could be implemented in software, hardware, or a combination thereof. In an exemplary embodiment illustrated in FIG. 3, the power management logic 104, along with its associated methodology, is implemented in a combination of software and hardware and stored in memory 308 of the hand-held printing device 100.

Note that the power management control logic 104, when implemented in software, can be stored and transported on any computer-readable medium for use by or in connection with an instruction execution system, apparatus, or device, such as a computer-based system, processor-containing system, or other system that can fetch and execute instructions. In the context of this document, a “computer-readable medium” can be any means that can contain, store, communicate, propagate, or transport a program for use by or in connection with the instruction execution system, apparatus, or device.

The exemplary embodiment of the hand-held printing device 100 depicted by FIG. 3 comprises at least one conventional processor 304, such as a central processing unit (CPU), that communicates to and drives the other elements within the device 100 via a local interface 306, which can include at least one bus.

As described hereinabove with reference to FIG. 1, the hand-held printing device 100 comprises a plurality of sensors 106. Such sensors 106 may include, but are not limited to, a media sensor 311, a home sensor 312, and/or a position encoder 313.

In one embodiment, as indicated hereinabove, the media sensor 311 preferably transmits a visible beam of light through an aperture (not shown) out the aperture 128 of the housing 117. The light transmitted is intended to be incident to the medium. The sensor 311 then receives reflected light from the beam transmitted. In this regard, the sensor 311 produces an output based upon the light reflected back to the sensor 311. The media sensor 311 may determine by the magnitude and/or angle of the light reflected back whether the surface upon which the aperture 128 is adjacent is flat and without obstruction so that the print head 110 can transfer an image to the medium. Other sensors are possible in other embodiment, for example, infrared reflective sensors or ultrasonic sensors might be used as the media sensor 311.

The home sensor 312 preferably verifies that the print head 110 (or the carriage that moves with the print head 110) is in the print head rest position. In one embodiment, the home sensor 312 is a mechanical microswitch. When the actuator 102 is actuated, the home sensor 312 changes state. Note that the home sensor 312 may be activated by the mechanical movement of the actuator 102 or the cam mechanism 103. When the actuator 102 is actuated, the print head 110 moves, and is therefore no longer in the print head rest position.

The control logic 104 may monitor the home sensor 312, periodically querying whether the state of the home sensor 312 has changed to indicate that the actuator 102 has been actuated or that the print head 110 is in the print head rest position. As described further herein, when the control logic 104 determines that the home sensor 312 has changed state to indicate that the actuator has actuated and the print head 110 is not longer in the rest position, the control logic 104 may further turn on the position encoder 313.

The position encoder 313 preferably is a sensor that can detect whether the print head 110 is moving and in which direction it is moving. For example, a standard open linear type sensor may be used that comprises a clear plastic strip having a pattern of dark bars spaced at different intervals. Such strip is coupled to the print head 110 or the carriage that moves the print head 110. As the print head 110 moves, the position encoder 313 is capable of detecting the position of the print head 110 and the direction that the print head 110 is traveling. Other position encoders are possible in other embodiments, for example rotary disks may be used coupled to the cam mechanism 103.

In light of the foregoing, in one embodiment, when the media sensor 311 detects that the device 100 has been properly positioned on an appropriate medium and the print head 110 is in the rest position, the control logic 104 synchronizes the time and/or date if required for the image being printed, powers on the position encoder 313, and warms the print head 110.

Note that the device is properly positioned when the aperture 128 (FIG. 1) is placed on the medium in a position that would enable proper printing, e.g., the aperture is not skewed in any manner that would disallow printing. Further note an appropriate medium is a medium suitable for printing, for example, the surface of the medium is not too coarse or bumpy.

In such an embodiment, the control logic 104 may print on the forward and/or the bidirectional stroke, as described hereinabove. During the forward and bidirectional strokes, the control logic 104 continues to warm the print head 110. Furthermore, if the media sensor 311 indicates that the device 100 is no longer positioned properly or that the medium is no longer appropriate, then the control logic 104 terminates the print cycle.

In another embodiment, the user powers on the device 100, as described hereinabove, and the control logic 104 determines whether the print head 110 is in the rest position. If the print head 110 is in the rest position, as described hereinabove, and the user selects an image for printing via the input device 125, then the control logic 104 begins warming the print head 110. However, in such an embodiment, the control logic. 104 waits until the user initiates a print cycle, (i.e., the user actuates the actuator 102), before performing other power-using operations, such as synchronizing the time and/or date, powering on the position encoder 313, or powering on the media sensor 311. In this regard, the cam mechanism 103 that translates the vertical actuator movement into the print head horizontal movement may be coupled to the home sensor 312, for example. Thus, when the user actuates the actuator 102, the home sensor 312 is activated and/or switched. In such an embodiment, the control logic 104 could monitor the home sensor 312 to determine whether the actuator 102 has been actuated. The control logic 104, therefore, can wait to activate, for example, the media sensor 311 or the position encoder 313 until the user has actuated the actuator 102. Such delay may prolong the life of the power source 131 by reducing the amount of time that some of the electronic components, e.g., the position encoder 313 or the media sensor 311, are powered on.

In this regard, instead of powering on some components when the media sensor 311 indicates that the device 100 is positioned on the medium, the control logic 104 waits until the user manually depresses the actuator 102. When the user actuates the actuator 102, then the home sensor 312 indicates that the print head 110 is no longer in its rest position. Thus, once the user actuates actuator 102, the control logic 104 synchronizes the date and/or time, powers on the position encoder 313, and warms the print head 110.

In yet another embodiment, the control logic 104 may wait until the user actuates the actuator 102 to perform some power-using operations, e.g., warming the print head 110, powering on the media sensor 311 or the position encoder 313, when the print head 110 is in its forward stroke, as described hereinabove. In such an embodiment, the control logic 104 prints the selected image on the reverse stroke, as described hereinabove. During the reverse stroke, the control logic 104 may continue to warm the print head 110. By printing on the reverse stroke and powering on other components during the forward stroke, the control logic 104 limits the amount of time that the print head 110 is warmed and the media sensor 311 and position encoder 313 are powered on. Therefore, the control logic 104 prolongs the life of the power source 131 (FIG. 1).

In yet another embodiment, as indicated hereinabove, the power management control logic 104 activates the media sensor 311, then performs other power-using operations upon actuation by the user and such operations may be performed when the print head 110 is in its forward stroke, as described hereinabove. During the reverse stroke, the control logic 104 may continue to warm the print head 110. By printing on the reverse stroke and performing other power-using operations during the forward stroke, the control logic 104 limits the amount of time that the print head 110 is warmed and the position encoder 313 is powered on. Therefore, the control logic 104 prolongs the life of the power source 131 (FIG. 1).

Furthermore, the control logic 104 may further be configured to ensure that the image selected for printing to the medium is available for printing. In this regard, the device 100 may further comprises image data 399 stored in memory 308. The image data 399 is data indicative of images to be printed to the medium via the print head 110. When a user selects an image for printing, prior to turning on the media sensor 311, the encoder 313 and/or synchronizing the date/time or warming the print head 110, the control logic 104 may receive an input from the user indicative of the image to be printed and retrieve the image from image data 399. If the control logic 104 is unable to retrieve the selected image from the image data 399, the control logic 104 may not power on the media sensor 311 or the encoder 313. Further, the control logic may alert the user that the image was unable to be retrieved from memory.

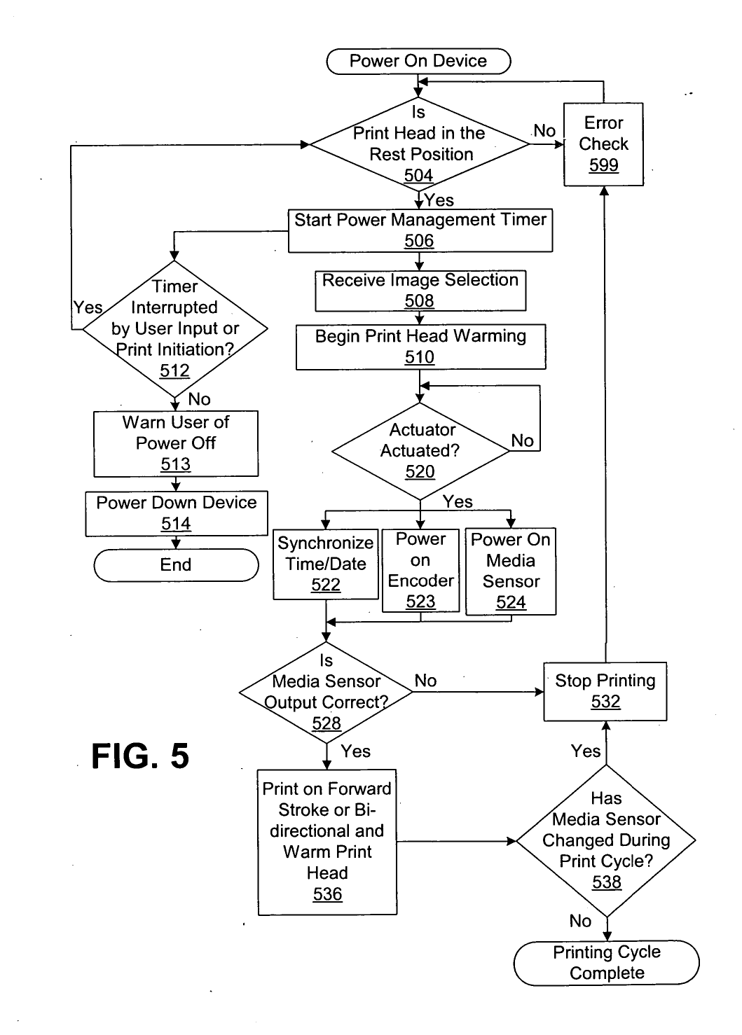

An exemplary architecture and functionality for the use and operation of the hand-held printing device 100 for printing on the forward stroke or bi-directionally are described hereafter with reference to FIG. 4 and 5.

With reference to FIG. 4, the power management control logic 104 (FIG. 1) powers on the media sensor 311 (FIG. 3) in step 402. In this regard, the power management control logic 104 may begin sampling the media sensor 311. In step 404, if the home sensor 312 (FIG. 3) indicates that the print head 110 (FIG. 1) is in the rest position, then the power management control logic 104 activates the power management timer 132 (FIG. 1) in step 406.

If the print head 110 is not in its rest position in step 404, then the power management control logic 104 performs error checking in step 499 and continues to monitor the home sensor 312 in step 404.

If the timer is not interrupted by user input or actuation of the actuator 102 in step 426 after a predetermined time, the power management control logic 104 warns the user that the device 100 is going to power down in step 427. The control logic 104 then powers down the device in step 428.

If the timer 132 is interrupted by user input or actuation of the actuator 102 in step 426, then the power management control logic 104 determines if the print head 110 is in the rest position in step 404 and restarts the timer in step 406 if the print head 110 is in its rest position. Note that steps 426 and 406 continue throughout the duration that the hand-held device 100 is powered on. In this regard, the timer 132 (FIG. 1) may continue to look for an interruption during the print cycle or while the device 100 is powered on. Thus, if after any step the device 100 goes idle for a predetermined amount of time, the control logic 104 will detect such and power down the device 100.

After the timer 132 is activated in step 406, the power management control logic 104 may receive an image selection from a user in step 408. The power management control logic 104 then determines whether the media sensor output is correct, i.e., if the device 100 is properly positioned on an appropriate medium, in step 410. In this regard, the media sensor 311 preferably transmits an output indicative of whether the device 100 is positioned on a medium. Note that the media sensor 311 may be configured to ensure that the medium on which the device 100 is placed is a medium suitable for printing, i.e., that the surface of the medium is not too coarse. Further, the media sensor 311 may be configured to ensure that the end 128 (FIG. 1) of the housing 117 (FIG. 1) is placed substantially parallel to the medium and is not skewed in any manner that might adversely affect printing.

If the device 100 is properly positioned in step 410, the power management control logic 104 synchronizes the time and the date in step 412, powers on the position encoder 313 in step 413, and warms the print head 110 in step 414. Thus, the device 100 is prepared for printing when the user actuates the actuator 102. However, if the media sensor 311 does not indicate that the device is positioned correctly in step 410, then the control logic 104 does not continue to the various operations in steps 412-414. Therefore, power from the power source 131 is not used to power such operations as described until the device 100 is ready for printing.

When the user actuates the actuator 102 (FIG. 1) in step 418, the power management control logic 104 communicates an image to the print head 110 and the print head 110 prints on the forward or bidirectional stroke of the print head and continues to warm the print head 110 in step 420 as the printing occurs. Note that warming the print head 110 in step 420 is preferable if the print head 110 needs to be warmed, and such necessity may be determined by control logic 104 in accordance with the particular print head 110 that is in use.

If during printing, the media sensor 311 changes state, i.e., the sensor no longer detects a medium on which to place the image, in step 422, then the control logic 104 terminates the print cycle in step 424 and performs error checking in step 499.

FIG. 5 depicts another embodiment of the power management control logic 104 (FIG. 1) of the present disclosure for printing on a forward stroke or bi-directionally upon actuation of the actuator 102 (FIG. 1).

The control logic 104 determines whether the print head 110 (FIG. 1) is in the rest position in step 504. If the print head 110 is in the rest position, then the control logic 104 starts the power management timer 132 (FIG. 1) in step 506. The timer 132 (FIG. 1) then operates as described hereinabove with reference to FIG. 4 in steps 512-514. If the print head 110 is not in the rest position, the power management control logic 104 performs error checking in step 599 and continues checking the home sensor 312 in step 504.

The control logic 104 receives an image selection via the input device 125 (FIG. 1) in step 508. Upon receipt of the image selection in step 508, the control logic 104 begins warming the print head 110 (FIG. 1) in step 510. By delaying warming the print head 110 until the image selection is made in step 508, the control logic 104 may reduce the amount of power used to warm the print head 110. In this regard, if the print head 110 is warmed and the user takes no further action, the timer 132 may expire and the control logic 104 may power down the device 100 without using the warmed print head 110.

When the user actuates the actuator 102 in step 520, the control logic 104 then activates the media sensor 311 in step 524, power on the encoder in step 523, and/or synchronize the time and/or date in step 522. Note that in FIG. 4, the media sensor 311 is activated in step 402 (FIG. 4). By waiting to activate the sensor 311 until the user actuates the actuator, the control logic 104 may further reduce the power used by the device 100, i.e., the amount of time that the media sensor 311 is power on is reduced in FIG. 5.

In this regard, the control logic 104 synchronizes the date and/or time in step 522, powers on the encoder in step 523, and activates the media sensor in step 524. Notably, such power-using operations occur prior to determining whether the media sensor 311 (FIG. 3) is detecting whether the device 100 is properly positioned on an appropriate medium.

In step 528, the control logic 104 determines whether the media sensor output is correct by evaluating an output of the particular media sensor 311. If the output is correct, i.e., the device 100 is correctly positioned on an appropriate medium, in step 528, then the control logic transmits an image to the print head 110 for printing on the forward stroke or bi-directionally in step 536. If the output is not correct in step 528, then the control logic 104 stops the print cycle in step 532 and performs error checking in step 599.

Once the print head 110 begins printing on the forward stroke or bi-directionally, if the media sensor 311 output changes while the print head 110 is printing, then the control logic 104 stops printing (step 532) and proceeds to perform error checking in step 599. Otherwise, the print cycle completes.

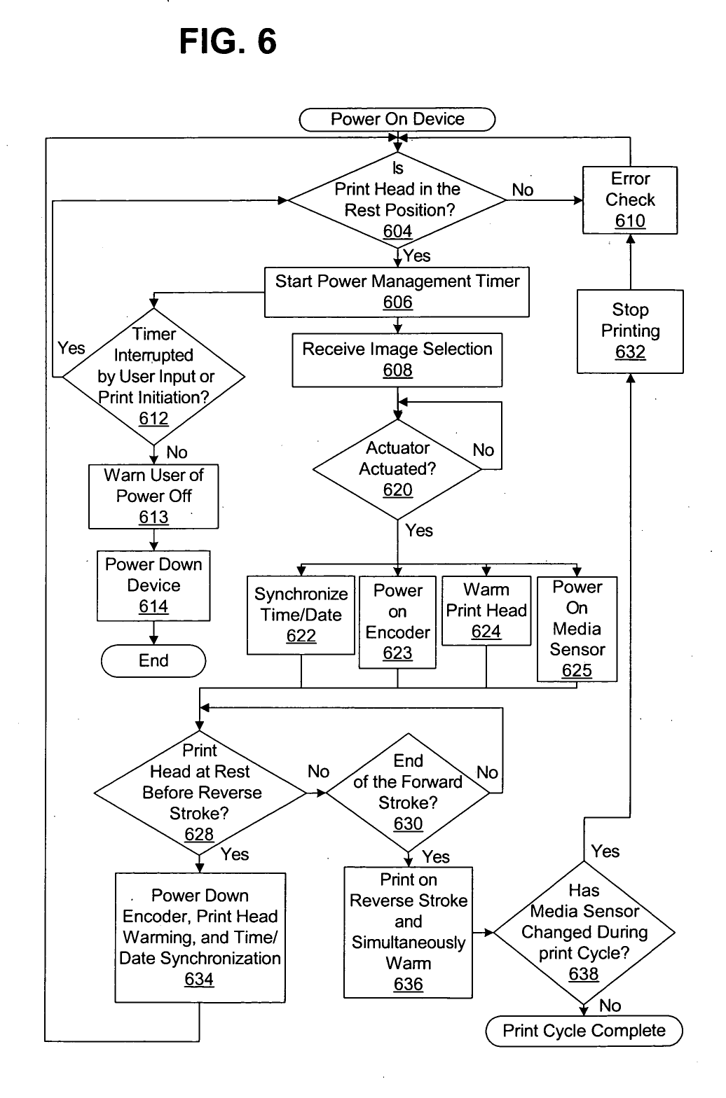

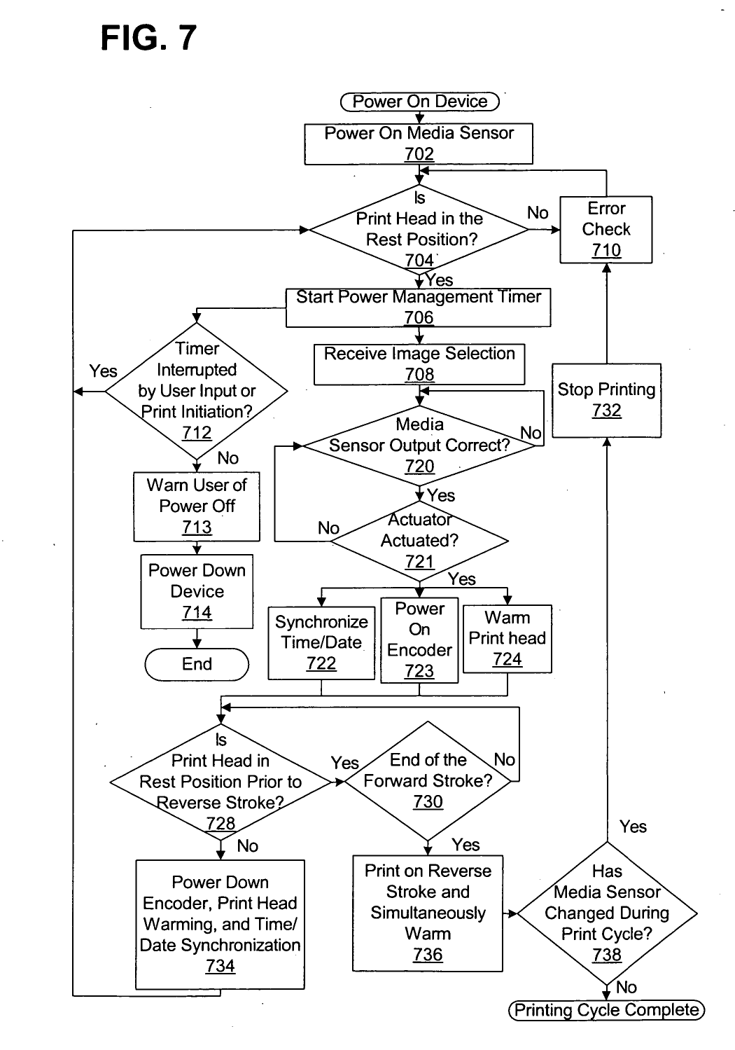

An exemplary architecture and functionality for the use and operation of the hand-held printing device 100 for printing on the reverse stroke are described hereafter with reference to FIG. 6 and 7.

With reference to FIG. 6, the control logic 104 (FIG. 1) determines whether the print head 110 (FIG. 1) is in the rest position in step 604. If it is not, then the control logic 104 performs error checking in step 610. If the print head 110 is in the rest position in step 604, then the control logic 104 starts the timer 132 (FIG. 1) in step 606. In step 608, the control logic 104 may receive an image selection. Note that the timer 132 operates in steps 612-614 as described with reference to FIG. 4 in steps 426-428.

The control logic 104 then waits in step 620 until a user actuates the actuator 102 before synchronizing the date in step 622, powering on the encoder 313 in step 623, warming the print head 110 in step 624 or powering on the media sensor 311 in step 625. By waiting, the control logic 104 reduces the amount of power used from the power source 131 (FIG. 1) thereby prolonging the life of the power source 131.Therefore, if the user does not actuate the actuator 102, then the power supply 131 is not used.

Before printing on the reverse stroke, the control logic 104 ensures that the print head 110 has not returned to the rest position before it begins its reverse stroke in step 628. If the device 100 is in the rest position before it begins its reverse stroke, then the control logic 104 powers down the position encoder 313, the media sensor 311, the print head 110, and the time and/or date synchronization in step 634.

If the print head 110 has not returned to the rest position before printing on the reverse stroke in step 628, the control logic 104 determines if the print head 110 is at the end of its forward stroke in step 630. If the print head 110 is at the end of its forward stroke in step 630, then the control logic 104 prints on the reverse stroke in step 636 and simultaneously warms the print head 110.

If the print head 110 stops or the media sensor output changes in step 638, then the control logic 104 terminates the print cycle in step 632 and performs error checking in step 610. If not then the print cycle completes.

FIG. 7 depicts another exemplary architecture and functionality of the power management control logic 104 for printing on the reverse stroke.

With reference to FIG. 7, the power management logic 104 (FIG. 1) powers on the media sensor 311 (FIG. 3) in step 702. In step 704, if the home sensor 312 (FIG. 3) indicates that the print head 110 (FIG. 1) is in the rest position, then the logic 104 activates the power management timer in step 706. If the print head 110 is not in the rest position in step 704, then the power management logic 104 performs error checking in step 710 and continues to monitor the home sensor 312 (FIG. 3) in step 704. The power management timer 132 behaves in steps 712-714 as described with reference to FIG. 4 in steps 426-428.

After the timer 132 is activated in step 706, the power management control logic 104 receives an image selection from a user in step 708. The power management control logic 104 then determines whether the output of the media sensor 311 is correct, i.e., if the device 100 is properly positioned on a medium, in step 720.

If the media sensor output is correct in step 720 and the user actuates the actuator 102 in step 721, the power management control logic 104 synchronizes the time and the date in step 722, powers on the encoder in step 723, and warms the print head 110 in step 724. By waiting until the user actuates the actuator in step 721, the power management control logic 104 reduces the amount of power used by the device 100. If the user does not actuate the actuator 102, then the control logic 104 continues to monitor the output of the media sensor 311 in step 720.

Note that the control logic 104 may control the print head 110 such that the power-using operations are performed during the forward stroke of the print head 110. By performing the power-using operations in the forward stroke of the print head 110, the control logic 104 may reduce the power used by the device 100 and reduce the amount of time for printing an image to the medium.

Before printing on the reverse stroke, the control logic 104 ensures that the print head 110 is not in the rest position before it begins its reverse stroke in step 728. If the print head 110 is in the rest position before it begins its reverse stroke, then the control logic 104 powers down the position encoder 313, the media sensor 311, the print head 110, and the time/date synchronization in step 734.

If the print head 110 has not returned to the rest position before printing on the reverse stroke in step 728, the control logic 104 determines if the print head 110 is at the end of its forward stroke in step 730 via the position encoder 313. If the position encoder 313 indicates that the print head 110 is at the end of its forward stroke in step 730, then the control logic 104 prints on the reverse stroke in step 736 and continues to warm the print head 110.

If the print head 110 stops, based upon the position encoder 313 or the home sensor 312, and the media sensor output changes in step 738, then the control logic 104 terminates the print cycle in step 732 and performs error checking in step 710. If not then the print cycle completes.

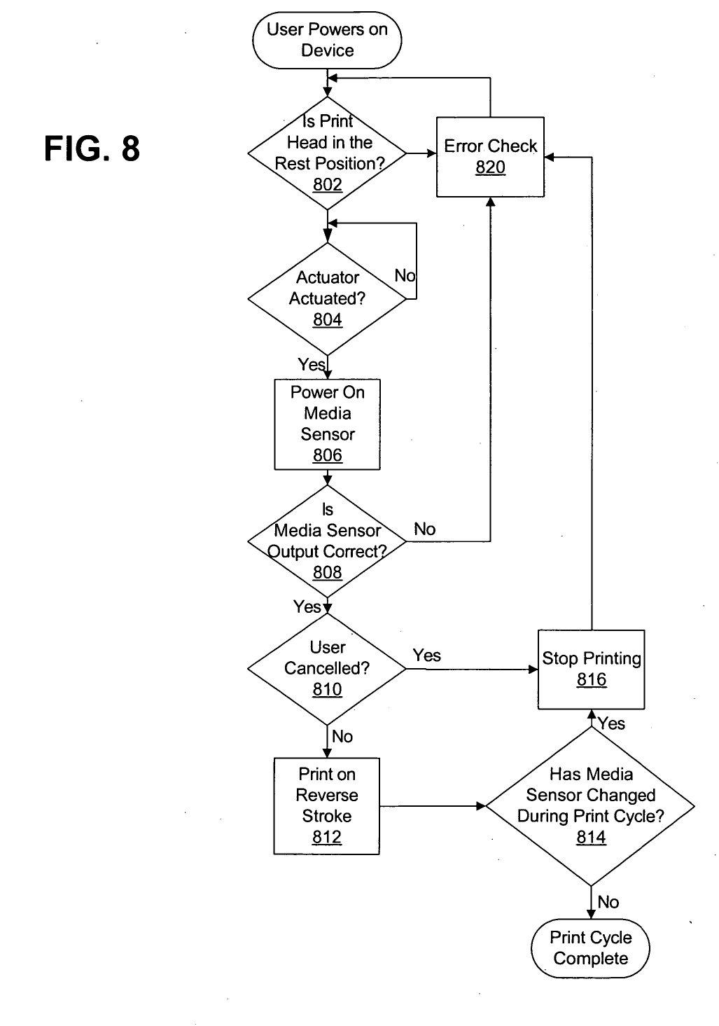

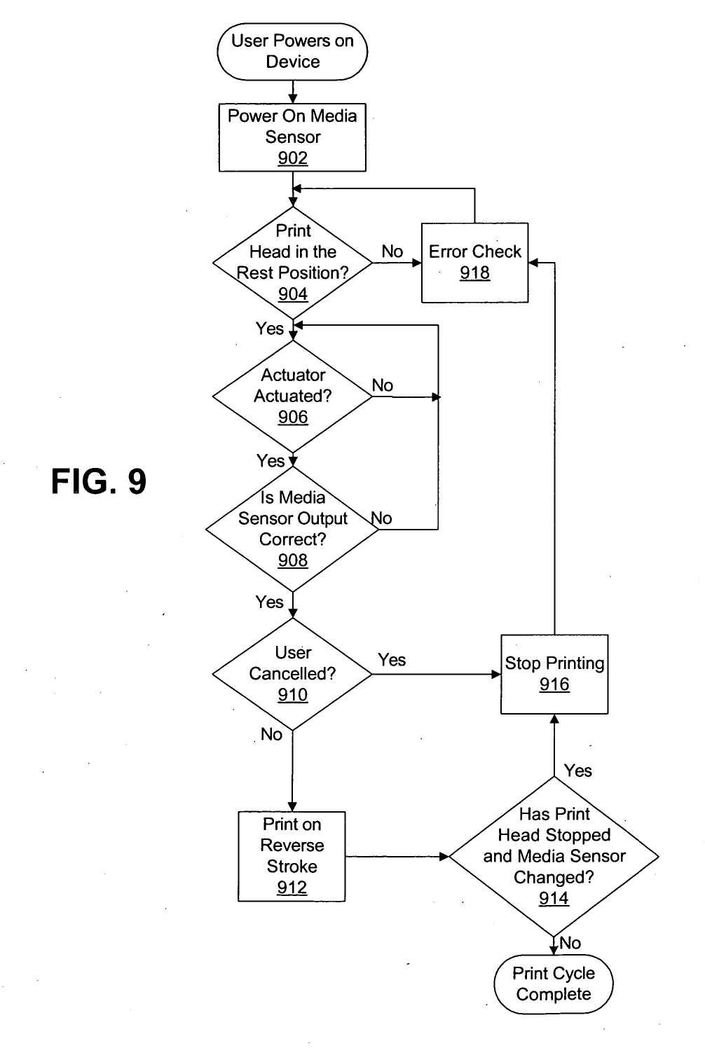

An exemplary architecture and functionality for the use and operation of the hand-held printing device 100 for cancelling a print cycle by a user when the device 100 is printing on the reverse stroke are described hereafter with reference to FIG. 8 and 9.

With reference to FIG. 8, the control logic 104 may determine whether the print head 110 (FIG. 1) is in the rest position in step 802, and if it is in the rest position, and the user actuates the actuator 102 in step 804, then the control logic 104 powers on the media sensor 311 in step 806.

If the print head 110 is not in the rest position in step 802, then the control logic 104 executes an error routine in step 820. If it is in the rest position, then the control logic 104 waits until the user actuates the actuator 102 to activate the media sensor 311 in step 806.

If the media sensor output is not correct in step 808, the control logic 104 executes an error routine in step 820. If the media sensor output s correct in step 808, and the user has not selected the cancellation button 133 (FIG. 1) in step 810, then the control logic 104 transmits an image to the print head 110 and the print head 110 prints on the reverse stroke in step 812. If the user selects the cancellation button 133, then the control logic 104 stops the print cycle in step 816 and performs error checking in step 820. If not, the print cycle completes.

If the print head 110 stops printing and the media sensor 311 changes in step 814, then the control logic 104 stops the print cycle in step 816.

FIG. 9 depicts another exemplary architecture and functionality of the power management control logic 104 for cancelling a print cycle by a user when the device 100 is printing on the reverse stroke.

The architecture and functionality of the logic 104 illustrated in FIG. 9 differs from that in FIG. 8 in that the media sensor 311 (FIG. 3) is activated in step 902 before the user actuates the actuator 102 in step 906. In such an embodiment, the media sensor 311 is active for a longer period of time. Furthermore, because the media sensor 311 is active for a longer period of time, more power is needed from the power source 131.

Thus, in step 902, the control logic 104 powers on the media sensor 311. If the print head 110 (FIG. 1) is in not in the rest position in step 904, then the control logic performs error checking in step 918. If the print head 110 is in the rest position in step 904, and the user actuates the actuator 102 in step 906, then the control logic 104 checks the output of the media sensor 311 in step 908. If the output indicates that the media is correct, and the user does not press the cancellation button 133 (FIG. 1) in step 910, then the control logic 104 prints on the reverse stroke in step 912.

If the print head 110 stops and the media sensor 311 changes in step 914, then the print cycle is complete. However, if the print head does not stop and the media sensor changes in step 914, then an error has occurred, and the control logic 104 stops printing in step 916 and performs error checking in step 918.

If the user selects the cancellation button 133 in step 910, then the control logic 104 stops printing in step 916.

Note that although sensors are referred to throughout the exemplary embodiments any number of similar input devices could be substituted such as, but not limited to mechanical, magnetic, electronic and optical switches, as well as combinations thereof.

1. A hand-held printing device, comprising:
a hand-operated actuator that moves a print head relative to a print medium;
at least one sensor; and
logic configured to perform at least one power-using operation of the hand-held device based on an output from the at least one sensor.

2. The device of claim 1, wherein when the actuator is actuated the print head moves.

3. The device of claim 2, wherein the actuator is mechanically actuated.

4. The device of claim 2, further comprising a button that, when selected, powers on a motor that moves the print head.

5. The device of claim 2, further comprising a mechanism that translates a motion of the actuator into a motion of the print head parallel to the medium.

6. The device of claim 1, wherein logic is configured to warm the print head during a forward stroke of the print head and print the image on a reverse stroke of the print head.

7. The device of claim 6, wherein the reverse stroke and the forward stroke are accomplished by the user manually moving the device.

8. The device of claim 1, further comprising a timer wherein the logic is configured to activate the timer when the device is powered on and deactivate the device if the device is idle for a predetermined period of time.

9. The device of claim 1, wherein the at least one operation includes warming the print head, and the logic is configured to warm the print head if the sensor indicates that the device is properly positioned on the medium.

10. The device of claim 1, wherein the logic is further configured to warm the print head after the logic determines that a selected image is resident on the device.

11. The device of claim 10, wherein the sensor is a media sensor configured to output a signal if the device is not properly positioned on the medium.

12. The device of claim 1, wherein the logic is configured to determine whether the actuator has been actuated and warm the print head based upon an output from the sensor.

13. The device of claim 1, wherein the logic is configured to delay the at least one power-using operation until the print head is in a forward stroke.

14. The device of claim 1, wherein the logic is configured to transmit an image to be printed to the print head on a reverse stroke of the print head.

15. The device of claim 14, wherein the logic is further configured to receive an input from a user via an input device, the input being indicative of cancellation of a print cycle, the logic further configured to cancel the print cycle in response to the input.

16. The device of claim 1, wherein the logic is further configured to cancel the print cycle in response to a user input.

17. The device of claim 16, wherein the logic is configured to cancel the print cycle during a forward stroke.

18. The device of claim 17, wherein the logic is configured to cancel the print cycle at the end of a forward stroke.

19. The device of claim 1, wherein the logic is further configured to warm the print head during a print cycle.

20. The device of claim 1, wherein the at least one operation comprises powering on a position encoder.

21. The device of claim 1, wherein the print head is an inkjet print head.

22. A printing method, comprising:
detecting, via a sensor, whether a hand-held printing device is properly positioned on a medium; and
performing at least one power-using operation of the hand-held device based on an output from the sensor.

23. The method of claim 22, further comprising activating a timer when the device is powered on and deactivating the device if the device is idle for a predetermined period of time.

24. The method of claim 22, further comprising warming the print head if the output indicates that the device is properly positioned on the medium.

25. The method of claim 22, further comprising receiving an input from a user via an input device indicative of cancellation of a print cycle.

26. The method of claim 25, further comprising cancelling the print cycle in response to the input.

27. The method of claim 26, further comprising cancelling the print cycle.

28. The method of claim 27, wherein the cancelling comprises cancelling the print cycle during a forward stroke of the print head.

28. The method of claim 27, wherein the cancelling comprises cancelling the print cycle at the end of a forward stroke.

29. The method of claim 22, wherein the power-using operation comprises activating a position encoder.

30. A hand-held device, comprising:
an actuator for activating an inkjet print head of the hand-held device for printing images to a medium;
at least one sensor configured to detect whether the hand-held device is ready for printing; and
means for performing a power-using operation based upon the detection of the at least one sensor.
